(19) United States
(12) Patent Application Publication
(10) Pub. No.: US 2016/0292507 A1
(43) Pub. Date: Oct. 6, 2016

(54) Information Processing System and Method Using Image Recognition

(71) Applicants: Ziad Ghoson, Dubai (AE); Stephanie El Khouri, Dubai (AE)

(72) Inventors: Ziad Ghoson, Dubai (AE); Stephanie El Khouri, Dubai (AE)

(21) Appl. No.: 15/084,128

(22) Filed: Mar. 29, 2016

Related U.S. Application Data
(60) Provisional application No. 62/139,863, filed on Mar. 30, 2015.
(60) Provisional application No. 62/182,753, filed on Jun. 22, 2015.
(60) Provisional application No. 62/183,503, filed on Jun. 23, 2015.

(51) Int. Cl. G06K 9/00; G06K 9/22; G06F 17/30; G06K 9/62

(52) U.S. Cl. CPC G06K 9/00671; G06K 9/6215; G06K 9/6202; G06K 9/22; G06F 17/30259; G06F 17/30528; G06F 17/30241

(57) ABSTRACT

There is provided a method and a system comprising a server adapted to be connected to a mobile application running on a mobile device for receiving an image captured by the mobile device and a user/mobile device location and/or contextual search information, the server being further adapted to be connected to an objects database comprising objects related images and objects related information, the server being further adapted to implement an object identification process and for retrieving landmark information related to the identified object of interest for enabling the users to conduct transactions with a mobile application running on the mobile device using the retrieved landmark information of the object.

### CROSS-REFERENCE

The present application claims priority of the U.S. provisional applications No. 62/139,863 filed on 30 Mar. 2015, U.S. 62/182753 filed on 22 Jun. 2015, and U.S. 62/183,503 filed on 23 Jun. 2015.

### FIELD OF THE INVENTION

The present invention generally relates to the field of image recognition, and more particularly to image recognition based mobile applications running on mobile devices, systems and methods.

### BACKGROUND OF THE INVENTION

Photographs are taken for a variety of personal and business reasons. During the course of the year, an individual may take numerous photographs of various places visited and other events. Mobile devices have become the primary electronic devices to capture images as high resolution cameras are available on mobile devices. However, photographs and images taken by such devices usually do not serve any purpose other than being kept in albums or hard disk for memory. Mobile devices are not capable of providing details of images captured by users and traditional technologies are also limited with regard to obtaining any information associated with taken images in a quick and easy manner.

### SUMMARY OF THE INVENTION

Therefore, a need exists for development of an improved image recognition based information processing system and method for processing images captured using mobile devices, for determining the objects associated to the images, for retrieving information related to the determined objects in the purpose of enabling users to use the retrieved information for conducting transactions using the mobile device.

As a first aspect of the present invention, there is provided a system for processing information about an object using image recognition, the system comprising:
a mobile application adapted to run on a mobile device;
a database comprising landmark, completed or in the process of completion, information about objects;
a database comprising landmark information about objects;
a remote server adapted to be connected to the mobile application and to the database for receiving captured images, identifying the related object using image recognition techniques, querying the database with the object identifier to retrieve information about the object and sending the information back to the mobile application for display to the users;

In an embodiment of the above aspect, the mobile application comprises an image capturing module, an image processing module, an information dissemination module, a user interface, and a transaction module.

As a second aspect of the present invention, there is provided an information processing method using image recognition, the method comprising:
capturing an image using a mobile device, the image being associated to an object;
transmitting the captured image to a remote server using the mobile device, the remote server comprising an image recognition processing unit;
processing the image using the image recognition processing unit for identifying the object associated to the image;
querying, by the server, a database comprising data mapping object identifiers to landmark information, the querying comprising using an object identifier associated to the identified object for retrieving landmark related information;
transmitting, by the server, the retrieved landmark information to the mobile device;
displaying using a user interface on the mobile device the retrieved information to the user; and
enabling the user to conduct transactions using the retrieved information using the mobile device.

As another aspect of the present invention, there is provided an improved information processing system using image recognition comprising:
a mobile application adapted to run on a user mobile device;
an objects database comprising images and information associated to objects;
a server adapted to be connected to the mobile application and to the objects database for receiving an image captured using the mobile device through the mobile application, receiving the location of the user/mobile device through the mobile application, processing the captured image as a function of the location of the user/mobile device for identifying the associated object, the processing comprising comparing the captured image to objects related images stored inside the objects database related to objects located within a certain geographical zone of the user/mobile device location, and once the object is identified, querying the objects database for retrieving landmark information about the identified object and sending the landmark information back to the mobile application for display to the user.

In an embodiment of the invention, the sever further receives contextual search information from the mobile application, wherein the processing of the captured image for determining the associated object is also conducted as a function of the contextual search information.

The contextual search information comprises categories of objects searched by the user within a given period of time prior to the query request. For example, if the user has been searching for restaurants using his mobile device, the likelihood that the captured image is associated to a restaurant is high and should be given priority while processing the captured image in the purpose of enhancing accuracy of results and speed in identifying the object.

Therefore, while the captured image is processed, the server compares the captured image to stored images related to restaurants and if there is a match, the search is concluded and the associated object is identified. If there is no match, the server compares the captured image to other types of images inside the objects database which can be related to any type of objects such as restaurants, theatres, animals, etc.

In an embodiment of the invention, the mobile application comprises an image capturing module, an image processing module, a location identification module, a prediction module, an information dissemination module, a user interface, and a transaction module.

The image capturing module is adapted to provide users access to the camera device of the mobile device for activating the camera for capturing an image of any desired object. The desired object can be any type of object, including but not limited to any retail outlets, food and beverage outlets, fashion outlets, any buildings which may include but not limited to malls, hotels, any other landmark buildings, and sculptures, any residential projects, any financial institutions such as banks, any transportation system such a public bus transport, taxi transport, water transports such as shipyards, and air transports such as airport, any public entertainment locations such as exhibitions, water parks, theme parks, beaches, parks, auditoriums, cinema complexes, zoo, bird sanctuaries, national parks and the like, any unfinished projects and living objects which may include human beings, animals or plants. The desired object can either be an image of the object itself or a representation of the object such as logos, marks including trademarks and/or any other suitable representative marks or pictures associated with the object.

The location identification module is adapted to be in communication with the image processing module for obtaining the geographical location of the user/mobile device and sending the user/mobile device location to the image processing module. The location identification module obtains the mobile device/user location by means of a Global Positioning System (GPS) location service, IP address or any suitable service/technique adapted for determining the geographical location of the mobile device/user. The image processing module receives the mobile device/user location information obtained by the location identification module.

The prediction module is adapted to be in communication with the image processing module for obtaining contextual search information and sending it to the image processing module for being taken into consideration while processing the captured image for identifying the associated object. The contextual search information can comprise categories of objects being recently searched by the user or other searching features such as recent locations or services searched by the user using the mobile device.

The image processing module is adapted to be in communication with the image capturing module, the location identification module, the prediction module, the server, the type of information selection module and the user interface. The image processing module receives the captured image from the image capturing module, in addition to the mobile device/user location from the location identification module and the contextual search information from the prediction module.

The image processing module prepares and transmits a query request to the server, the query request comprising the captured image, the user/mobile device location and/or the contextual information. The purpose of the query request is for determining the identity of the object associated with the captured image and, in an embodiment, for retrieving landmark information about the identified object.

In an embodiment of the invention, the server is a remote server and the query request is sent from the mobile device to the sever through a wireless data network comprising at least one of a mobile phone network and the Internet.

As a further aspect of the invention, there is provided a system comprising a server adapted to be connected to a mobile application running on a mobile device for receiving an image captured by the mobile device and a user/mobile device location, the server being further adapted to be connected to an objects database comprising objects related images and objects related information, the server being further adapted to implement an object identification process comprising the steps of:
a. searching in the objects database and compiling a list of possible objects as a function of the location of the user/mobile device, where the possible objects are those located within a given geographical zone from the location of the user/mobile device;
b. comparing the captured image to the possible objects for determining if there is a match with any one of these possible objects;
c. if a match is found between the captured image and one of the possible objects, determining the identity of the object associated with the captured image.

In an embodiment of the invention, the server is further adapted to receive contextual search information form the mobile application, the object identification process further comprising the steps of:
d. searching in the objects database and compiling a list of possible objects as a function of contextual search information, where the possible objects are those being within the same category of objects searched by the user according to the contextual search information;
e. comparing the captured image to the possible objects for determining if there is a match with any one of these possible objects;
f. if a match is found between the captured image and one of the possible objects, determining the identity of the object of interest associated with the captured image.

In an embodiment of the invention, the search based on the location of the user/mobile device is conducted before the search based on the contextual search information, and wherein the search based on the contextual search information is conducted based on the list of possible objects obtained conducting the search based on the user/mobile device location.

In an embodiment of the invention, the search based on the location of the contextual search information is conducted before the search based on the mobile device/user location, and wherein the search based on the mobile device/user location is conducted based on the list of possible objects obtained conducting the search based on the contextual search information.

In an embodiment of the invention, the object determination process comprises:
g. First, comparing the captured image with all objects' related images stored inside the objects database for determining if a match can be found;
h. Second, if a perfect match cannot be found, compiling a list of possible objects based on the comparison process in the first step where the possible objects are those having a certain degree of resemblance with the captured image (but not a complete match);
i. Third, filtering the list of possible objects based on the user/mobile device location and/or the contextual search information, where the filtering process comprises determining the objects among the possible objects which are located within a given geographical zone from the location of the user/mobile device and/or which are within the same category of objects searched by the user according to the contextual search information;
j. Fourth, if a match is found between the captured image and one of the filtered objects, determining the identity of the object associated with the captured image;
k. Fifth, if a match is not found, obtaining and sending the filtered list of objects to the user for selection of the right object of interest among the filtered list of objects.

In an embodiment of the invention, the steps of the object identification process are conducted in the same order as recited.

In an embodiment of the invention, the steps of the object identification process are conducted in the same order as recited.

In an embodiment of the invention, the server is further adapted to obtain landmark information related to the object of interest and transmitting the landmark information to the mobile device.

In an embodiment of the invention, the mobile application is adapted to enable the user of the mobile device to:
capture the image using a mobile device, the image being associated to an object;
obtain the user/mobile device location and/or contextual search information;
transmit the captured image along with the user/mobile device and/or contextual search information to a remote server via a wireless data network using the mobile device;
receive an identification of the object associated with the captured image;
receive landmark information associated with the identified object;
display the identified object and the landmark information to the user using a user interface; and
enable the user to conduct transactions using the retrieved landmark information using the mobile device.

As a further aspect of the invention, there is provided a mobile application adapted to run on a processing unit of a mobile device for:
Enabling a user to capture an image using a mobile device, the image being associated to an object;
obtain the user/mobile device location and/or contextual search information;
transmit the captured image along with the user/mobile device and/or contextual search information to a remote server via a wireless data network using the mobile device, the remote server comprising an image recognition processing unit adapted to process the captured image on light of the user/mobile device and/or contextual search information for identifying the object related to the captured image;
receive an identification of the object associated with the captured image;
receive landmark information associated with the identified object;
display the identified object and the landmark information to the user using a user interface; and
enable the user to conduct transactions using the retrieved landmark information using the mobile device.

As a further aspect of the invention, there is provided a mobile device running a mobile application adapted to:
Enable a user to capture an image using a mobile device, the image being associated to an object;
obtain the user/mobile device location and/or contextual search information;
transmit the captured image along with the user/mobile device and/or contextual search information to a remote server via a wireless data network using the mobile device, the remote server comprising an image recognition processing unit adapted to process the captured image on light of the user/mobile device and/or contextual search information for identifying the object related to the captured image;
receive an identification of the object associated with the captured image;
receive landmark information associated with the identified object;
display the identified object and the landmark information to the user using a user interface; and
enable the user to conduct transactions using the retrieved landmark information using the mobile device.

### BRIEF DESCRIPTION OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates an information processing system using image recognition in accordance with an embodiment of the invention.

FIG. 2 illustrates an information processing method using image recognition in accordance with an embodiment of the invention.

FIG. 3 illustrates an information processing system using image recognition in accordance with another embodiment of the invention.

FIG. 4 illustrates the components of a mobile application running on a mobile device in communication with the remote server and third party servers in accordance with an embodiment of the invention.

FIG. 5 illustrates an improved information processing system using image recognition in accordance with an embodiment of the invention.

FIG. 6 illustrates an improved information processing process using image recognition in accordance with an embodiment of the invention.

FIG. 7 illustrates a mobile user interface screen in accordance with another embodiment of the invention.

FIG. 8 illustrates the components of an improved mobile application running on a mobile device in communication with the remote server and third party servers in accordance with an embodiment of the invention;

FIG. 9 illustrates an improved system for object identification using a server in accordance with an embodiment of the invention.

FIG. 10 illustrates an improved system for object identification using a server in accordance with another embodiment of the invention.

FIG. 11 illustrates an improved object determination process using a server in accordance with an embodiment of the invention.

FIG. 12 illustrates an improved mobile application in accordance with an embodiment of the invention.

FIG. 13 illustrates an improved mobile device running a mobile application in accordance with an embodiment of the invention.

### DETAILED DESCRIPTION OF THE INVENTION

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

Basic System and Method:

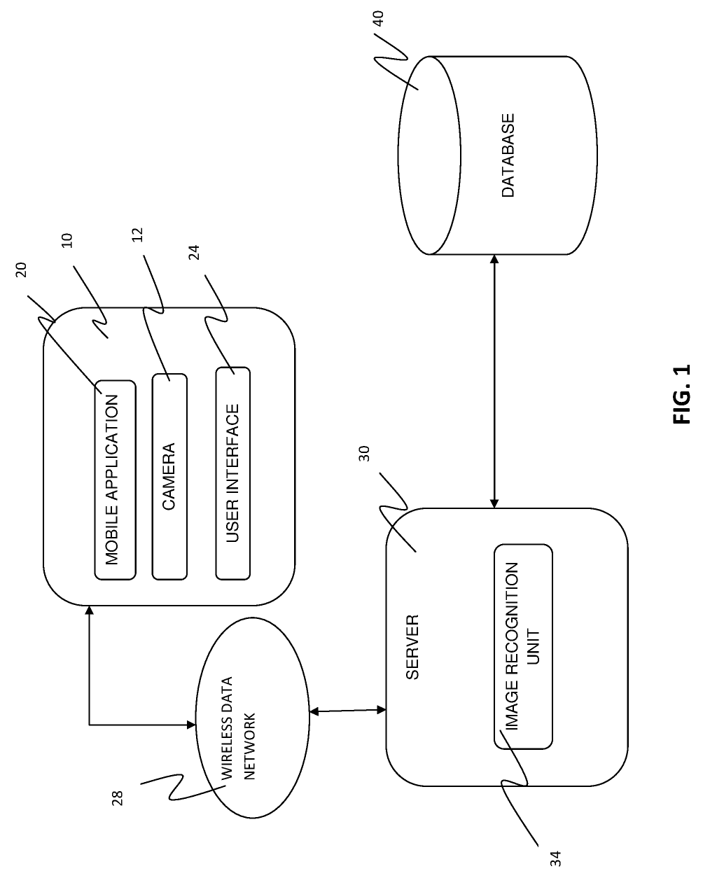

FIGS. 1 to 4 illustrate some embodiments of the basic system and method.

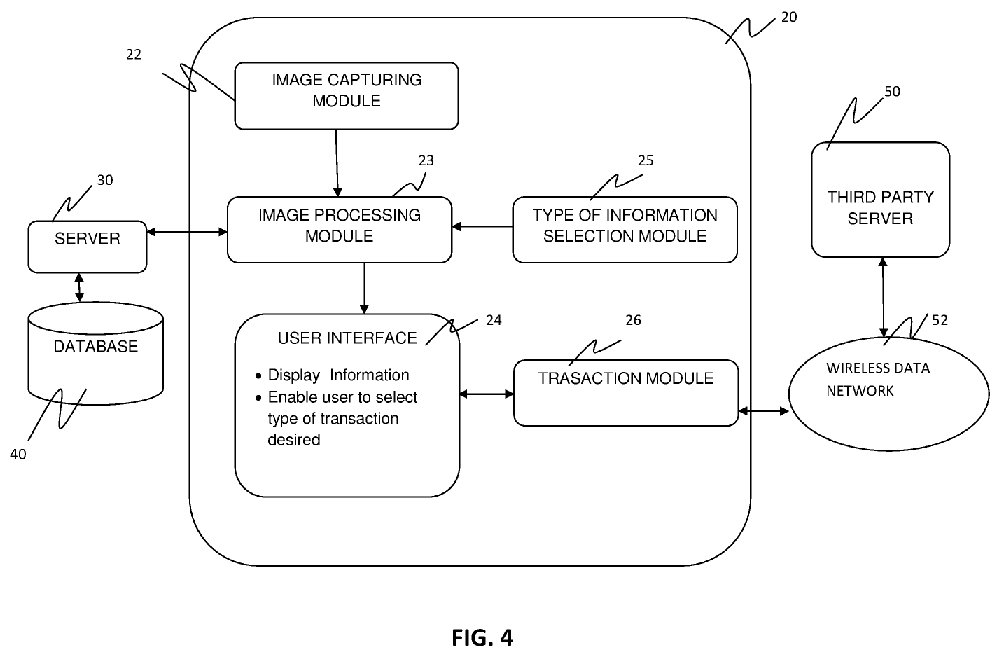

Referring to FIGS. 1 and 4, there is provided an information processing system comprising a mobile application 20 adapted to run on a mobile device 10, a server 30 comprising an image recognition unit 34 and a database 40 comprising data mapping object identifiers to object related information. The mobile application 20 comprises an image capturing module 22 adapted to enable the user to capture an image of a desired object using the camera 12 of the mobile device 10.

The image capturing module 22 is adapted to be connected to the camera of the mobile device 12 for controlling the camera 12 for capturing an image of a desired object. The mobile application 20 further comprises an image processing module 23 in communication with the image capturing module 22 for receiving and processing the image by generating a query request to the server comprising the image. A query comprising the captured image is therefore generated by the image processing module 23 and sent to the server 30 through the wireless data network 52.

The image recognition unit 34 receives the captured image and processes the image for identifying the object associated to the image. An object identifier is retrieved by the server for the purpose of identifying the object. The server 30 is then adapted to query the database 40 using the object identifier to retrieve information stored inside the database 40 in connection with the object. Information about the captured image is retrieved by the database 40 and communicated to the server 30.

The server 30 receives the object related information of the identified object and transmits the retrieved information to the mobile device 10 by means of wireless data network 28. The image processing module 23 of the mobile application 20 is adapted to be in communication with the user interface 24 of the mobile device 10 for receiving the object related information and displaying the information to the user through the user interface 24. The user is then enabled through the user interface 24 to visualize the object related information.

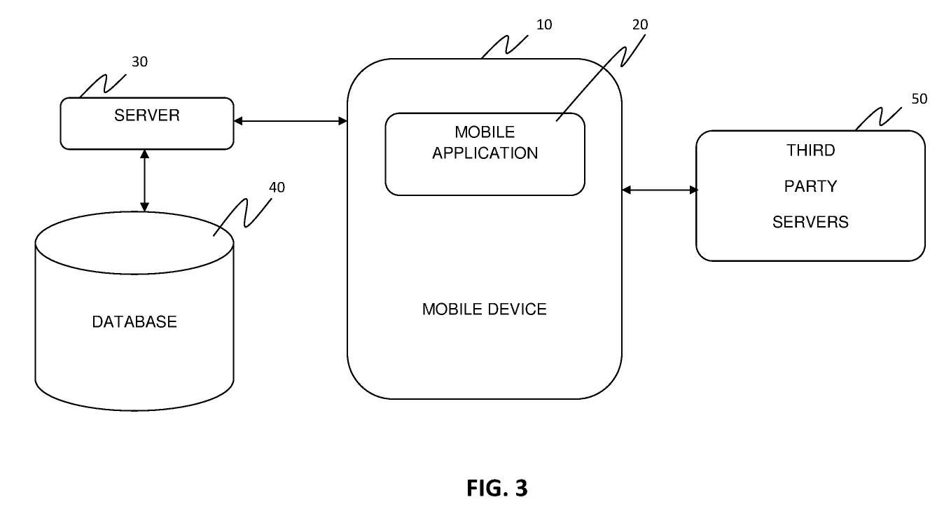

In an embodiment of the invention, as illustrated in FIGS. 3 and 4, the mobile application 20 further comprises a transaction module 26 adapted to be in communication with the user interface 24 for enabling the user to conduct transactions using the object related information. The transaction module 26 is adapted to provide the user with a menu of available transactions among which the user can select any desired transaction to conduct. The transaction module 26 is adapted to determine the available transactions based on the type of object and the type of information retrieved from the database 40. The transaction module 26 is adapted to be connected to third party servers 50 via a wireless data network 52 for conducting the transactions.

In an embodiment of the invention, the mobile application 20 further comprises an information selection module 25 adapted to enable the user to select the type of information desired in connection with the object. In this case, the information selection module 25 is adapted to be connected to the user interface 24 for reading input data entered by the user for the type of information desired. The information selection module 25 is further adapted to be connected to the image processing module 23 for transmitting thereto the type of information desired by the user. The query generated by the image processing module 23 further comprises in this case the type of information desired along with the captured image. In this case, the server 30 queries the database 40 for retrieving only information related to the specific type of information specified by the user. According to this embodiment, object related information stored inside the database 40 is classified according to predetermine information types. These information types correspond to those made available for selection by the user on the mobile device side.

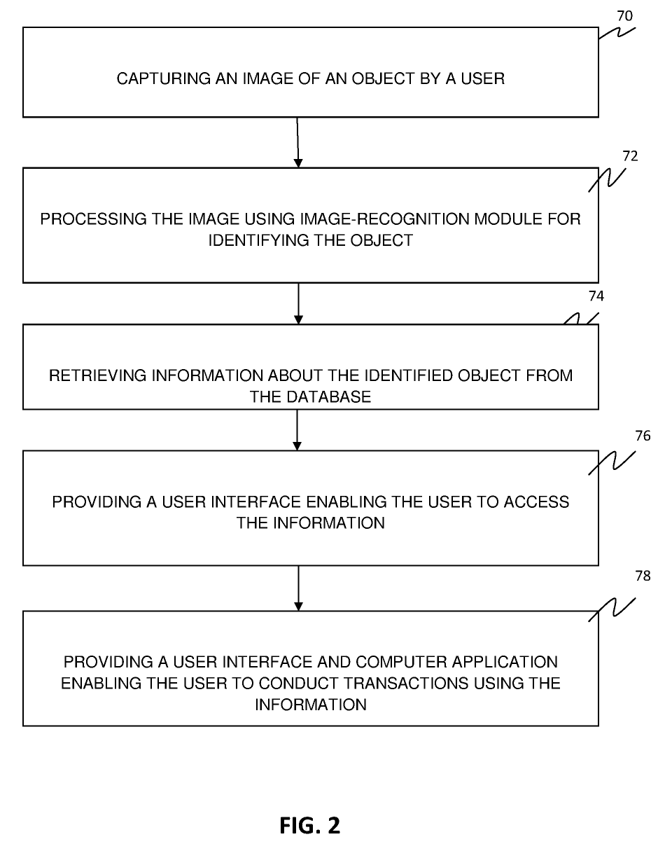

Referring to FIG. 2, there is provided an information processing method using image recognition comprising the steps of capturing an image of a desired object by a user 70, processing the image using an image recognition module for identifying the object 72, retrieving the information about the identified object from a database storing data mapping object identifiers to object related information 74, enabling user access to the object related information though a user interface at the mobile device 76, and enabling the user to conduct transactions using the information 78.

Referring to FIG. 4, as explained above, the mobile application 20 comprises an image capturing module 22 adapted to access the camera 12 of the mobile device 10 to capture images of a desired object. The image captured by the image capturing module 22 is communicated to image processing unit 23 which is adapted to communicate with the server 30 via a data network 28 to recognize the image by identifying the object related thereto and retrieve information about the recognized object from the database 40. The information retrieved by the server 30 is transmitted to the mobile device 10 where the information is further processed by the image processing module 23. The image processing unit 23 is adapted to categorize the information into various categories for purpose of displaying these to the user via the user interface 24 in different categories or to provide the information in uncategorized format to the user interface 24.

The mobile application 20 comprises a type of information selection module 25 adapted to enable the user to select the information that the user wishes to select. The image processing unit 23 processes the type information selected by user and provides user access to the information via the user interface 24. The user interface 24 displays the information processed by the image processing module 23 and further enables the user to select any type of transaction desired by the user. The type of transaction selected by the user is communicated to the transaction module 26 which further communicates with third party servers 50 via the data network 52 to conduct the transaction.

The functionality details of the information processing system and method can be further explained by means of the following examples which do not limit the scope of the present invention.

### EXAMPLE 1

The user uses the camera 12 of the mobile device 10 to capture the image of the retail fashion outlet. The image is processed by using the image recognition unit 34 which identifies the fashion outlet and further retrieve information such as any promotional offers available, sales, other special offers, available products from the external database 40. The information retrieved is provided to user by means of the user interface 24. The user interface 24 allows the user to access the information to select the desired information such as size and pattern of the clothes available and further enables the user to conduct desired transactions such as browsing and buying the products by connecting to the third party servers 50 such as the office website of the retail outlet to complete the transaction.

### EXAMPLE 2

The user uses the camera 12 of the mobile device 10 to capture the image of the food and beverage outlet. The image is processed by the using the image recognition unit 34 which identifies the food and beverage outlet and further retrieve information such as any information about the outlet, menu, prices, dress code etc. from the external database 40. The information retrieved is provided to user by means of user interface 24. The user interface 24 allows the user to access the information to select the desired information such as availability of table opening and closing time etc. and further enables the user to conduct desired transactions such as booking table, booking catering service etc. by connecting to the third party servers 50 such as the office website of the food and beverage outlet to complete the transaction.

### EXAMPLE 3

The user uses the camera 12 of the mobile device 10 to capture the image of the mall, or the logo of the mall. The image is processed by using the image recognition unit 34 which identifies the mall and further retrieve information such as information about the outlets in the mall, various locations inside the mall, GPS guide to a desired outlet, cinema showing now and coming soon, parking availability etc. from the external database 40. The information retrieved is provided to user by means of user interface 24. The user interface 24 allows the user to access the information to select the desired information such as availability of tickets for the cinema, opening and closing time of any desired outlet etc. and further enables the user to conduct desired transactions such as booking tickets etc. by connecting to the third party servers 50 such as the office website of the cinema hall to complete the transaction.

### EXAMPLE 4

The user uses the camera 12 of the mobile device 10 to capture the image of a zoo, or the image of the logo of the zoo. The image is processed by using the image recognition unit 34 which identifies the zoo and further retrieve information such as any information about the animals in the zoo, show times of any animal shows etc. from the external database 40. The information retrieved is provided to user by means of user interface 24. The user interface 24 allows the user to access the information to select the desired information such as availability of tickets, opening and closing time of the zoo etc. and further enables the user to conduct desired transactions such as buying tickets etc. by connecting to the third party servers 50 such as the office website of the zoo to complete the transaction.

### EXAMPLE 5

The user uses the camera 12 of the mobile device 10 to capture the image of the airport terminal, or the logo of the airport. The image is processed by the using the image recognition unit 34 which identifies the airport terminal and further retrieve information such as any information about the airport, flight information, terminal specific information, airline specific information etc. from the external database 40. The information retrieved is provided to user by means of user interface 24. The user interface allows the user to access the information to select the desired information such as availability of flight tickets to any selected destination, status of the desired flight etc. and further enables the user to conduct desired transactions such as booking tickets, cancelling and rescheduling flights etc. by connecting to the third party servers 50 such as the office website of the airport or the airlines to complete the transaction.

### EXAMPLE 6

The user uses the camera 12 of the mobile device 10 to capture the image of any unfinished project, or its logo. The image is processed by the using the image recognition unit 34 which identifies the type of project and further retrieve information such as expected date of completion, future plans, information on further developments etc. from the external database 40. The information retrieved is provided to user by means of user interface 24. The user interface 24 allows the user to access the information to select the desired information such as type of outlets to be available etc. and further enables the user to conduct desired transactions such as booking office space or outlets etc. by connecting to the third party servers 50 such as the office website of the construction company to complete the transaction.

### EXAMPLE 7

The user uses the camera 12 of the mobile device 10 to capture the image of the hotel, or logo of the hotel. The image is processed by the using the image recognition unit 34 which identifies the hotel and further retrieve information such as any information about the hotel, types of rooms available, room rates, other facilities etc. from the external database 40. The information retrieved is provided to user by means of user interface 24. The user interface 24 allows the user to access the information to select the desired information such as room availability etc. and further enables the user to conduct desired transactions such as room booking table etc. by connecting to the third party servers 50 such as the office website of the hotel to complete the transaction.

### EXAMPLE 8

The user uses the camera 12 of the mobile device 10 to capture the image of the transportation vehicle such as public bus or taxi, or the logo. The image is processed by the using the image recognition unit 34 which identifies the transport authority and further retrieve information such as any information about the bus route, specific information about the taxi service etc. from the external database 40. The information retrieved is provided to user by means of user interface 24. The user interface 24 allows the user to access the information to select the desired information such as route numbers of the bus, timing of the bus etc. and further enables the user to conduct desired transactions such as purchasing tickets, booking the taxi etc. by connecting to the third party servers 50 such as the office website of the transportation authority to complete the transaction.

### EXAMPLE 9

The user uses the camera 12 of the mobile device 10 to capture the image of a bank, or its logo. The image is processed by the using the image recognition unit 34 which identifies the bank and further retrieve information such as any information about the bank, location of the branches, location of ATM facilities, other services available etc. from the external database 40. The information retrieved is provided to user by means of user interface 24. The user interface 24 allows the user to access the information to select the desired information such as working hours of the bank, formalities for opening the account, other net banking facilities etc. and further enables the user to conduct desired transactions such as opening a new account, transfer money etc. by connecting to the third party servers 50 such as the office website of the bank to complete the transaction.

Improved System and Method:

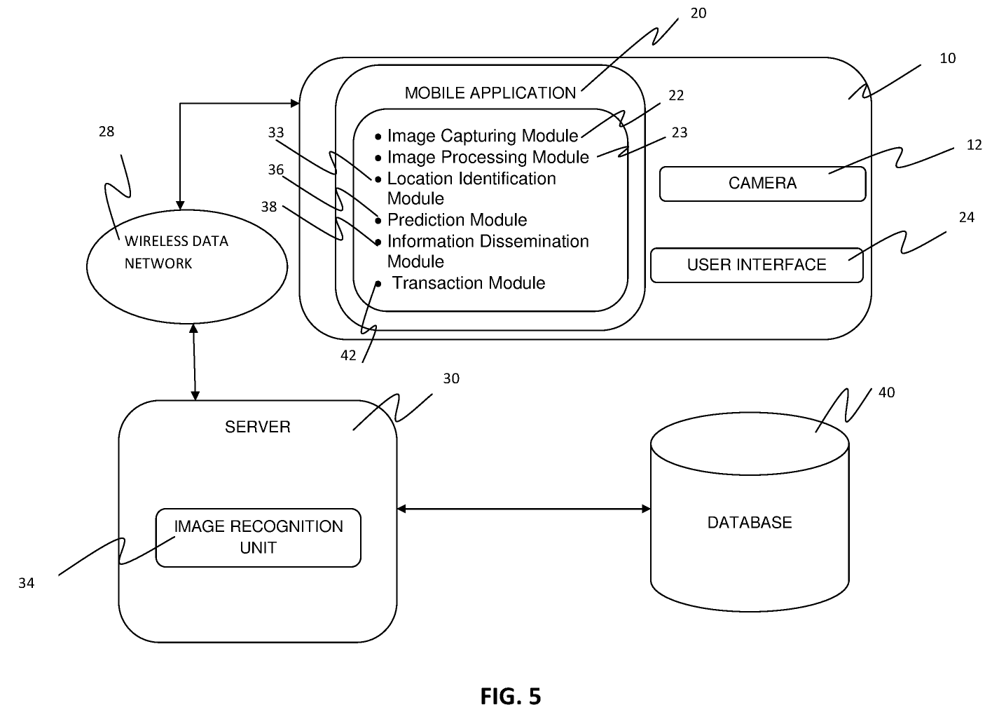

FIGS. 5 to 13 illustrate some embodiments of the improved system and method.

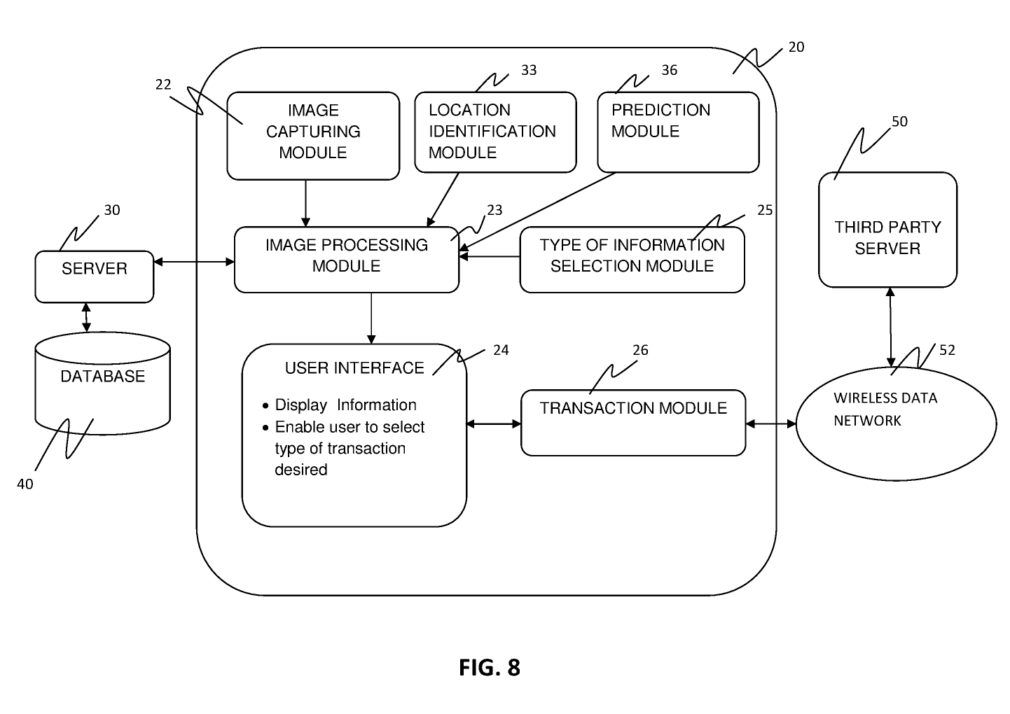

Referring to FIGS. 5 and 8, there is provided a mobile application 20 adapted to run on a mobile device 10, a server 30 comprising an image recognition unit 34 and an objects database 40 comprising data mapping object identifiers to object related information.

The mobile application 20 comprises an image capturing module 22 adapted to enable the user to capture an image of a desired object using the camera 12 of the mobile device 10. The image capturing module 22 is adapted to be connected to the camera of the mobile device 12 for controlling the camera 12 for capturing and obtaining an image of a desired object.

The mobile application 20 further comprises a location identification module 33 adapted to obtain the location of the user/mobile device 10. The location identification module 33 is adapted to be connected to a positioning system, such as a GPS system or any other suitable positioning system adapted to obtain a location of the mobile device. In an embodiment of the invention, the location identification module 33 assesses the distance between the user/mobile device and the object for which an image is taken (in case a picture is taken of the object of interest). Once the distance is estimated, the location identification module estimates the location of the objection as a function of the location of the user/mobile device and the estimated distance between the user/mobile device and the object of interest. The user/mobile device location is defined in the present application to include at least one of the user/mobile device location and the object location estimated by the location identification module.

The mobile application further comprises a prediction module 36 adapted to receive contextual search information of the user. In an embodiment of the invention, the prediction module 36 is adapted to be connected to a search engine running on the mobile device 10 for receiving the contextual search information. In another embodiment, the prediction module 36 stores previous searches made by the user using the mobile application 20 such as previous objects searched and it predicts future searches of interest of the user based on previous ones. The prediction module 36 is also adapted to be connected to the settings of the mobile application 20 for obtaining information related to the user, such as age, gender and location, date and time and predicts elements of interest of the user.

For example, if the user is within the territory of habitual residence and during the work time, it is unlikely that the user will be looking for touristic locations for entertainment and would be more likely to be looking for objects related to work such as events locations, restaurants for lunch invitations, and the like. The prediction module 36 is obtain settings information including job position, job location, gender, age, elements of interest (such as hobbies), habitual place of work, habitual place of residence and other relevant information in the purpose of predicting and defining likelihood of objects of interest (based on categories) which are to be searched by the user. The prediction module 36 is also adapted to enable the user to specify in real time his/her desired activities (such as sport exercising, lunch time, dinner time, cinema entertainment, etc) which are take into account for predicting/defining the possible objects of interest in future searches by the user. The prediction module 36 defines the contextual search information comprising one or more likely categories of objects of interest the user is likely to be searching. The contextual search information is preferably updated by the prediction module 36 in real time.

The mobile application 20 further comprises an image processing module 23 connected to the image capturing module 22 for receiving the captured image taken by the user which can be a picture of an object of interest, a logo or any representation thereof. The image processing module 23 is further connected to the location identification module 33 for receiving the user/mobile device location, and to the prediction module 36 for receiving the contextual search information which is defined by the prediction module as mentioned above.

The image processing module 23 is connected to the server 30 via a data network 52 for processing the image by generating a query request to the server 30 comprising the captured image in addition to at least one of the geographical location of the user/mobile device 10 and the contextual search information. Preferably, the query request comprises both the location of the user/mobile device and the contextual search information in addition to the image of the object of interest. A query comprising the captured image and/or location information is therefore generated by the image processing module 23 and sent to the server 30 through the wireless data network 52.

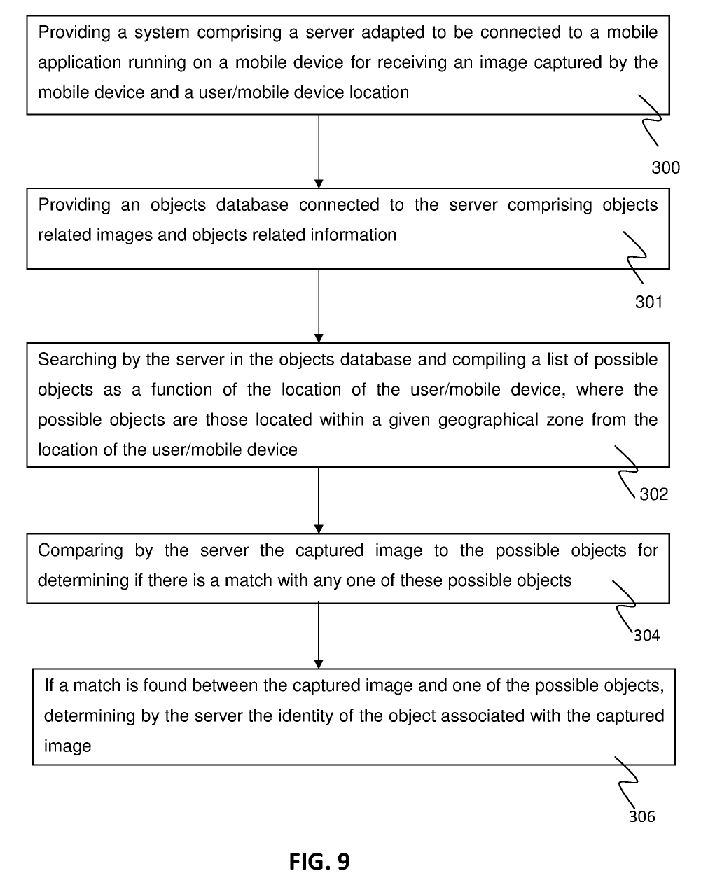

Referring to FIGS. 9-13 the image recognition unit 34 (at the server side 30) receives the captured image of the object of interest, the mobile device/user location and/or the contextual search information and processes the image using an object identification process implemented/conducted by the server for identifying the object associated to the image as a function of the received information. The object identification process is explained more in detail below.

The object identification process produces one or more possible objects of interest related to the image captured by the user. The one or more possible objects of interest correspond to those images inside the objects database 40 which present a likelihood of resemblance with the captured image beyond a certain predefined threshold defined by the object identification process. The listed possible objects of interest (possible matches) are compiled based on the captured image, user/mobile device location and/or contextual search information according to a suitable algorithm.

In case where there is an exact match and a single object of interest is identified by the image recognition unit 34, an identification of the object is transmitted to the mobile device 10 for communication to the user. In case where the image recognition unit 34 fails to identify a single object of interest and instead generates multiple possible objects of interest having some degree of likelihood of match based on the captured image and location of the user/mobile device and/or contextual information, the image recognition unit 34 does not identify the object, the server 30 transmits the list of possible matches to the mobile application (at the mobile device side) where the server 30/mobile application 20 prompts the user with the most likely match and a prompt message for confirming the accuracy of the match. If the user confirms that the most likely match is correct, then the server 30 sends a query to the objects database 40 to retrieve information related to the selected object stored inside the objects database 40. If the user confirms that the most likely match is incorrect, then the user is invited to select the desired match among the other relevant matches of the list or prompted to search by name or prompted to take another image of the object. Once the user selects the right match, the mobile application sends the selection to the server 30 which is then adapted to receive the selected object and query the objects database 40 using the selection to retrieve information stored inside the objects database 40 in connection with the object. Information about the captured image is retrieved by the objects database 40 and communicated to the server 30 which is then communicated to the mobile application 20 (at the mobile device 10 side).

The server 30 receives the object related information of the identified object and transmits the retrieved information to the mobile device 10 by means of wireless data network 28. The image processing module 23 of the mobile application 20 is adapted to be in communication with the user interface 24 of the mobile device 10 for receiving the object related information and displaying the information to the user through the user interface 24. The user is then enabled through the user interface 24 to visualize the object related information.

In an embodiment of the invention, the mobile application 20 further comprises a transaction module 26 adapted to be in communication with the user interface 24 for enabling the user to conduct transactions using the object related information. The transaction module 26 is adapted to provide the user with a menu of available transactions among which the user can select any desired transaction to conduct. The transaction module 26 is adapted to determine the available transactions based on the type of object and the type of information retrieved from the objects database 40. The transaction module 26 is adapted to be connected to third party servers 50 via a wireless data network 52 for conducting the transactions.

In an embodiment of the invention, the mobile application 20 further comprises an information selection module 25 adapted to enable the user to select the type of information desired in connection with the object. In this case, the information selection module 25 is adapted to be connected to the user interface 24 for reading input data entered by the user for the type of information desired. The information selection module 25 is further adapted to be connected to the image processing module 23 for transmitting thereto the type of information desired by the user. The query generated by the image processing module 23 further comprises in this case the type of information desired along with the captured image. In this case, the server 30 queries the objects database 40 for retrieving only information related to the specific type of information specified by the user. According to this embodiment, object related information stored inside the objects database 40 is classified according to predetermine information types. These information types correspond to those made available for selection by the user on the mobile device side.

The server uses image recognition techniques to identify the object associated with the captured image as a function of the user/mobile device location and/or the contextual search information.

Referring to FIG. 9, in an embodiment of the invention, the object identification process conducted by the server 30 comprises:
a. First, searching in the objects database and compiling a list of possible objects as a function of the location of the user/mobile device, where the possible objects are those located within a given geographical zone from the location of the user/mobile device (302);
b. Second, comparing the captured image to the possible objects for determining if there is a match with any one of these possible objects (304);
c. Third, if a match is found between the captured image and one of the possible objects, determining the identity of the object associated with the captured image (306).

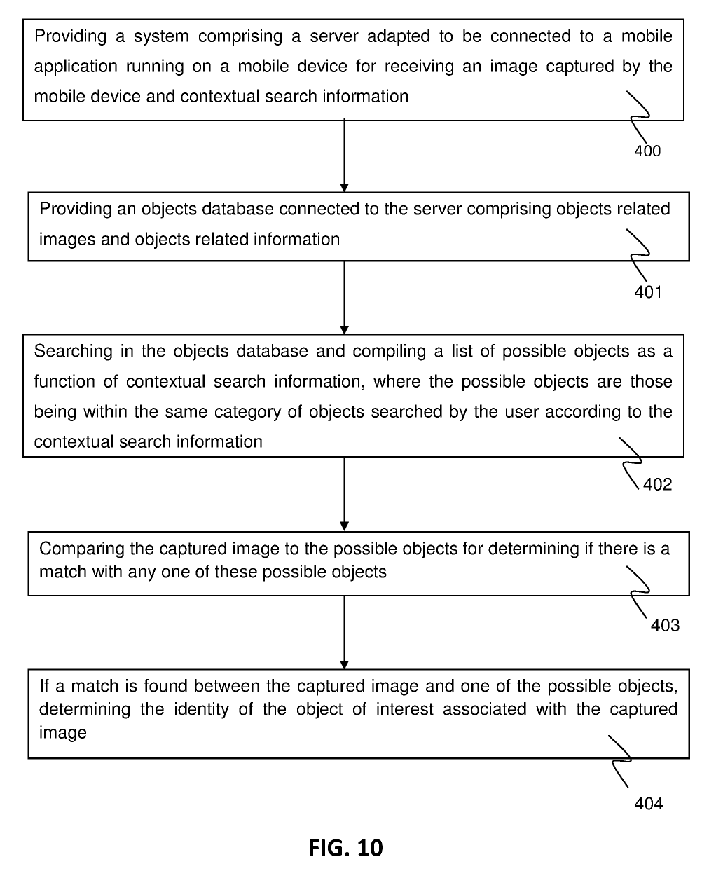

Referring to FIG. 10, in another embodiment of the invention, the object determination process comprises:
a. First, searching in the objects database and compiling a list of possible objects as a function of contextual search information, where the possible objects are those being within the same category of objects searched by the user according to the contextual search information (402);
b. Second, comparing the captured image to the possible objects for determining if there is a match with any one of these possible objects (403);
c. Third, if a match is found between the captured image and one of the possible objects, determining the identity of the object associated with the captured image (404).

In another embodiment of the invention, the object determination process comprises:
a. First, searching in the objects database and compiling a list of possible objects as a function of the location of the user/mobile device and contextual search information, where the possible objects are those located within a given geographical zone from the location of the user/mobile device and being within the same category of objects searched by the user according to the contextual search information;
b. Second, comparing the captured image to the possible objects for determining if there is a match with any one of these possible objects;
c. Third, if a match is found between the captured image and one of the possible objects, determining the identity of the object associated with the captured image.

In the above embodiments, referring to FIGS. 9 and 10, the object determination process preferably further comprises:
a. Providing a system comprising a server adapted to be connected to a mobile application running on a mobile device for receiving an image captured by the mobile device and a user/mobile device location (300/400);
b. Providing an objects database connected to the server comprising objects related images and objects related information (301/401);

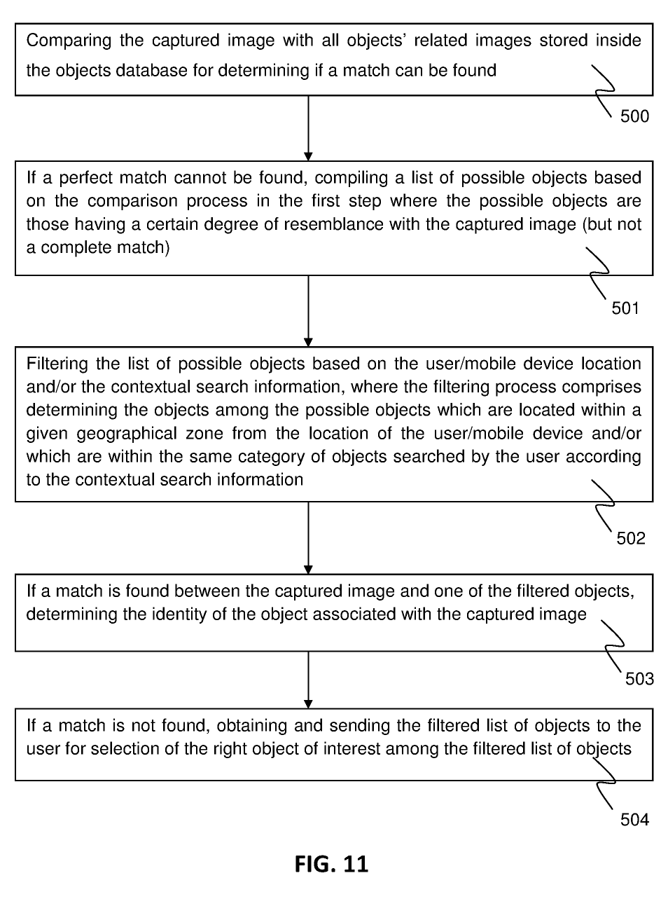

Referring to FIG. 11, in an embodiment of the invention, the object determination process comprises:
a. First, comparing the captured image with all objects' related images stored inside the objects database for determining if a match can be found (500);
b. Second, if a perfect match cannot be found, compiling a list of possible objects based on the comparison process in the first step where the possible objects are those having a certain degree of resemblance with the captured image (but not a complete match) (501);
c. Third, filtering the list of possible objects based on the user/mobile device location and/or the contextual search information, where the filtering process comprises determining the objects among the possible objects which are located within a given geographical zone from the location of the user/mobile device and/or which are within the same category of objects searched by the user according to the contextual search information (502);
d. Fourth, if a match is found between the captured image and one of the filtered objects, determining the identity of the object associated with the captured image (503);
e. Fifth, if a match is not found, obtaining and sending the filtered list of objects to the user for selection of the right object among the filtered list of objects (504).

The above embodiments disclose different ways of compiling the user/mobile device location and the contextual search information for determining the identity of the object. In the preferred embodiment, both the user/mobile device location and the contextual search information are used for determining the identity of the object, where a list of possible objects is first determined based on this information before initiating the comparison process with the captured image. This embodiment is likely to be the quickest and less encumbering from the data processing perspective.

The given geographical zone is a geographical zone within a certain radial distance from the user/mobile device location, such as 500 meters, 1 kilometer, 2 kilometer and the like. The contextual search information comprises at least one category of landmarks such as restaurant, residential building, hotel and the like.

The prediction module 36 of the mobile application 20 is adapted to monitor the searches of the user and to identify and store the categories of information searched. The prediction module 36 can also be connected to a search engine running on the mobile device for receiving this information. This contextual search information is preferably updated and stored in real time.

The objects database 40 preferably stores object related images in a classified manner, as a function of their respective locations and categories. In consequence, with classified object related images, it will be simple for the server to search and determine objects located within a given geographical zone and/or belonging to a given category based on the user/mobile device location and contextual search information received.

In an embodiment of the invention, if a single match is not found between captured image and the object related images stored in the objects database, the server 30 sends the list of possible objects to the user, where the mobile application is adapted to receive and display the list of possible objects to the user for selection of the right object among them.

Each object preferably has an identifier, such as a name, an alphanumerical code or a number. Once the object is identified, the remote server then queries the objects database using the object identifier for retrieving landmark information associated with the object. This information is sent back to the mobile device 10 for communication to the user through the user interface 24.

The information selection module 25 is adapted to be in communication with the image processing module 23 for enabling the user to select the desired type of information in association with the object associated to the image. There may be a wide range of information available to one specific object and the user may want to narrow down the retrieved information to a specific type of information. The information selection module 25 is adapted to be connected to the user interface 24 for enabling the user to select/identify any specific type of information desired in connection with the object. The query request generated by the image processing module 23 comprises in this case the specific type of information desired by the user. In this case, the remote server will query the objects database 40 for retrieving only the identified type of information desired about the identified object. Only the specific type of information is sent back to the mobile device 10 in this case.

The transaction module 26 is adapted to be in communication with the user interface 24 for enabling the user to conduct transactions, such as commercial transactions, using the information retrieved in association with the object. The transaction module 26 is adapted to be connected to third party servers via a data network 52 for processing the transactions.

The remote server 30 comprises an image recognition unit 34 for receiving the captured image, location information and/or contextual search information from the mobile device 10 (i.e. image processing module 23) and for identifying the object associated to the image. Once the object is identified, the server 30 queries the objects database 40 using an object identifier for retrieving landmark information related to the object. If the image recognition unit 34 does not determine an absolute match, the server 30 identifies the most likely match and sends the information to the mobile device 10 the image along with the prompt for the user to confirm the accuracy of the image. If user confirms the identified image as correct the server connects to the objects database 40 to retrieve information about the confirmed image. If the user confirms the identified image as incorrect, the server 30 provides the user with a list of objects based located with a given geographical zone in proximity of the user/mobile device location. The object identity and the information retrieved from the objects database 40 in association with the object are sent to the mobile device 10 to be made available to the user through the user interface 24.

The objects database 40 is adapted to be in communication with the server 30, either locally or remotely, and act as a source of information to the server 30.

As a second aspect of the present invention, there is provided an improved information processing method using image recognition comprising an object identification process comprising the steps of:
Receiving at a server an image associated to an unidentified object captured using a user mobile device;
Receiving at the server a user/mobile device location at the time the image was captured and/or contextual search information associated with the user;
Searching by the server in the objects database and compiling a list of possible objects as a function of the location of the user/mobile device and/or contextual search information, where the possible objects are those located within a given geographical zone from the location of the user/mobile device and/or being within the same category of objects searched by the user according to the contextual search information;
Comparing by the server the captured image to the possible objects for determining if there is a match with any one of these possible objects;
If a match is found between the captured image and one of the possible objects, determining the identity of the object associated with the captured image.

In an embodiment of the invention, the steps of the object identification process are conducted with the same order as recited above.

In another embodiment of the invention, the object identification process comprises:
a. First, comparing the captured image with all objects' related images stored inside the objects database for determining if a match can be found;
b. Second, if a perfect match cannot be found, compiling a list of possible objects based on the comparison process in the first step where the possible objects are those having a certain degree of resemblance with the captured image (but not a complete match);
c. Third, filtering the list of possible objects based on the user/mobile device location and/or the contextual search information, where the filtering process comprises determining the objects among the possible objects which are located within a given geographical zone from the location of the user/mobile device and/or which are within the same category of objects searched by the user according to the contextual search information;
d. Fourth, if a match is found between the captured image and one of the filtered objects, determining the identity of the object associated with the captured image;
e. Fifth, if a match is not found, obtaining and sending the filtered list of objects to the user for selection of the right

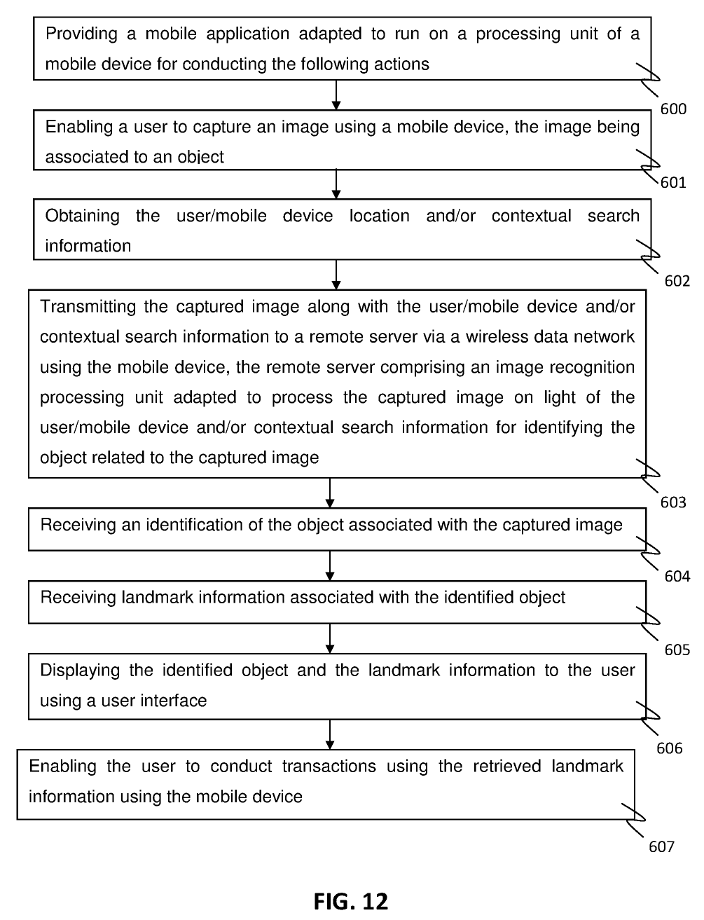

Referring to FIG. 12, in a further aspect of the invention, there is provided a mobile application 20 adapted to run on a user mobile device 10 (600), the mobile application 20 being adapted to enable the user to:
capture an image using a mobile device, the image being associated to an object (601);
obtain the user/mobile device location and/or contextual search information (602);
transmit the captured image along with the user/mobile device and/or contextual search information to a remote server via a wireless data network using the mobile device, the remote server comprising an image recognition processing unit adapted to process the captured image on light of the user/mobile device and/or contextual search information for identifying the object related to the captured image (603);
receive an identification of the object associated with the captured image (604);
receive landmark information associated with the identified object (605);
display the identified object and the landmark information to the user using a user interface (606); and
enable the user to conduct transactions using the retrieved landmark information using the mobile device (607).

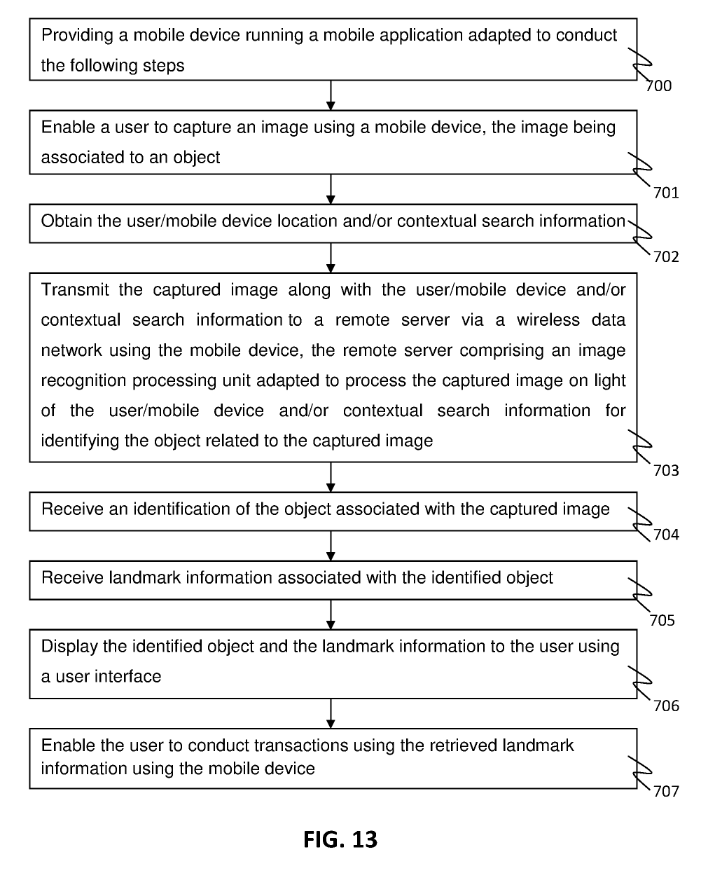

Referring to FIG. 13, in a further aspect of the invention, there is provided a mobile device 10 running a mobile application 20 (700) adapted to conducted the following steps:
capture an image using a mobile device, the image being associated to an object (701);
obtain the user/mobile device location and/or contextual search information (702);
transmit the captured image along with the user/mobile device and/or contextual search information to a remote server via a wireless data network using the mobile device, the remote server comprising an image recognition processing unit adapted to process the captured image on light of the user/mobile device and/or contextual search information for identifying the object related to the captured image (703);
receive an identification of the object associated with the captured image (704);
receive landmark information associated with the identified object (705);
display the identified object and the landmark information to the user using a user interface (706); and
enable the user to conduct transactions using the retrieved landmark information using the mobile device (707).

In an embodiment of the above aspects, if the image recognition unit 34 fails to exactly identify the captured image, the mobile application 20 is adapted to receive a list of possible objects (matches) and to enable the user to select an object among the possible objects; if the user confirms an object as an accurate match, the server 30 sends query to an objects database to obtain relevant information about the identified object.

In an embodiment of the invention, if the user rejects the list of possible objects (matches) to be accurate, the mobile application 20 is adapted to receive from the server 30 a list of possible matches based on the location of the user/mobile device and/or contextual search information. The user may select one of the possible matches or capture the image again using the mobile device 10.

The server 30 uses image recognition techniques to identify the object associated with the captured image as a function of the user/mobile device location and/or the contextual search information.

In an embodiment of the invention, the object identification process is conducted by the server 30 using the captured image and the mobile device/user location information, wherein the object identification process comprises:
a. First, searching in the objects database and compiling a list of possible objects as a function of the location of the user/mobile device, where the possible objects are those located within a given geographical zone from the location of the user/mobile device;
b. Second, comparing the captured image to the possible objects for determining if there is a match with any one of these possible objects;
c. Third, if a match is found between the captured image and one of the possible objects, determining the identity of the object associated with the captured image.

In another embodiment of the invention, the object determination process is conducted by the server 30 using the captured image and the contextual information, wherein the object identification process comprises:
a. First, searching in the objects database and compiling a list of possible objects as a function of contextual search information, where the possible objects are those being within the same category of objects searched by the user according to the contextual search information;
b. Second, comparing the captured image to the possible objects for determining if there is a match with any one of these possible objects;
c. Third, if a match is found between the captured image and one of the possible objects, determining the identity of the object associated with the captured image.

In another embodiment of the invention, the object determination process is conducted by the server 30 using the captured image and both the mobile device/user location information and the contextual search information, wherein the object identification process comprises:
a. First, searching in the objects database and compiling a list of possible objects as a function of the location of the user/mobile device and contextual search information, where the possible objects are those located within a given geographical zone from the location of the user/mobile device and being within the same category of objects searched by the user according to the contextual search information;
b. Second, comparing the captured image to the possible objects for determining if there is a match with any one of these possible objects;
c. Third, if a match is found between the captured image and one of the possible objects, determining the identity of the object associated with the captured image.

In an embodiment of the invention, where both the mobile device/user location information and contextual search information are used, the object identification process first processes the possible matches based on the user/mobile device location and then filters up the obtained possible matches using the contextual search information.

In an embodiment of the invention, where both the mobile device/user location information and contextual search information are used, the object identification process first processes the possible matches based on the contextual search information and then filters down the possible matches using the user/mobile device location.

In an embodiment of the invention, the object determination process is conducted by the server 30 by comparing the captured image to all images stored inside the objects database first and then, if no exact match is found, uses the user/mobile device location and/or the contextual search information to filter the obtained possible matches in the purpose of obtaining an exact match. In this case, as a possible embodiment of the invention, the object determination process comprises:
a. First, comparing the captured image with all objects' related images stored inside the objects database for determining if a match can be found;
b. Second, if a perfect match cannot be found, compiling a list of possible objects based on the comparison process in the first step where the possible objects are those having a certain degree of resemblance with the captured image (but not a complete match);
c. Third, filtering the list of possible objects based on the user/mobile device location and/or the contextual search information, where the filtering process comprises determining the objects among the possible objects which are located within a given geographical zone from the location of the user/mobile device and/or which are within the same category of objects searched by the user according to the contextual search information;
d. Fourth, if a match is found between the captured image and one of the filtered objects, determining the identity of the object associated with the captured image;
e. Fifth, if a match is not found, obtaining and sending the filtered list of objects to the user for selection of the right object among the filtered list of objects.

The above embodiments disclose different ways of compiling the user/mobile device location and the contextual search information for determining the identity of the object. In the preferred embodiment, both the user/mobile device location and the contextual search information are used for determining the identity of the object, where a list of possible objects is first determined based on this information before initiating the comparison process with the captured image. This embodiment is likely to be the quickest and less encumbering from the data processing perspective.

The given geographical zone can be a geographical zone within a certain radial distance from the user/mobile device location, such as 500 meters, 1 kilometer, 2 kilometer and the like. The contextual search information can be defined to include at least one category of objects such as restaurant, residential buildings, hotels, aquariums and the like.

As mentioned above, the prediction module of the mobile application can be adapted to monitor the searches of the user and to identify and store the categories of information searched. The prediction module can also be connected to a search engine running on the mobile device for receiving this information. This contextual search information is preferably updated and stored in real time.

The objects database preferably stores object related images in a classified manner, as a function of their respective locations and categories. In consequence, with classified object related images, it will be simple for the server to search and determine objects located within a given geographical zone and/or belonging to a given category based on the user/mobile device location and contextual search information received.

In an embodiment of the invention, if a single match is not found between captured image and the object related images stored in the objects database, the server sends the list of possible objects to the user, where the mobile application is adapted to receive and display the list of possible objects to the user for selection of the right object among them.

Each object preferably has an identifier, such as a name, an alphanumerical code or a number. Once the object is identified, the remote server then queries the objects database using the object identifier for retrieving landmark information associated with the object. This information is sent back to the mobile device for communication to the user through the user interface.

The information selection module is adapted to be in communication with the image processing module for enabling the user to select the desired type of information in association with the object associated to the image. There may be a wide range of information available to one specific object and the user may want to narrow down the retrieved information to a specific type of information.

The information selection module is adapted to be connected to the user interface for enabling the user to select/identify any specific type of information desired in connection with the object. The query request generated by the image processing module comprises in this case the specific type of information desired by the user. In this case, the remote server will query the objects database for retrieving only the identified type of information desired about the identified object. Only the specific type of information is sent back to the mobile device in this case.

The transaction module is adapted to be in communication with the user interface for enabling the user to conduct transactions, such as commercial transactions, using the information retrieved in association with the object. The transaction module is adapted to be connected to third party servers via a data network for processing the transactions.

The remote server 30 comprises an image recognition unit 34 for receiving the captured image, location information and/or contextual search information from the mobile device (i.e. image processing module) and for identifying the object associated to the image.

According to an embodiment of the invention, once the object is identified, the server 30 queries the objects database using an object identifier for retrieving landmark information related to the object. If the image recognition unit 34 does not determine an absolute match, the server 30 identifies the most likely match and sends the information to the mobile device the image along with the prompt for the user to confirm the accuracy of the image. If the user confirms the identified image as correct the server connects to the objects database to retrieve information about the confirmed object of interest. If the user confirms the identified object as incorrect, the server provides the user with a list of objects based located with a given geographical zone in proximity of the user/mobile device location. The object identity and the information retrieved from the objects database in association with the object are sent to the mobile device to be made available to the user through the user interface.

The objects database is adapted to be in communication with the server, either locally or remotely, and act as a source of information to the server.

As another aspect of the present invention, there is provided an improved information processing method using image recognition comprising an object identification process comprising the steps of:
Receiving at a server an image associated to an unidentified object captured using a user mobile device;
Receiving at the server a user/mobile device location at the time the image was captured and/or contextual search information associated with the user;
Searching by the server in the objects database and compiling a list of possible objects as a function of the location of the user/mobile device and/or contextual search information, where the possible objects are those located within a given geographical zone from the location of the user/mobile device and/or being within the same category of objects searched by the user according to the contextual search information;
Comparing by the server the captured image to the possible objects for determining if there is a match with any one of these possible objects;
If a match is found between the captured image and one of the possible objects, determining the identity of the object associated with the captured image.

In an embodiment of the invention, the steps of the object identification process are conducted with the same order as recited above.

In another embodiment of the invention, the object identification process comprises:
a. First, comparing the captured image with all objects' related images stored inside the objects database for determining if a match can be found;
b. Second, if a perfect match cannot be found, compiling a list of possible objects based on the comparison process in the first step where the possible objects are those having a certain degree of resemblance with the captured image (but not a complete match);
c. Third, filtering the list of possible objects based on the user/mobile device location and/or the contextual search information, where the filtering process comprises determining the objects among the possible objects which are located within a given geographical zone from the location of the user/mobile device and/or which are within the same category of objects searched by the user according to the contextual search information;
d. Fourth, if a match is found between the captured image and one of the filtered objects, determining the identity of the object associated with the captured image;
e. Fifth, if a match is not found, obtaining and sending the filtered list of objects to the user for selection of the right

In a further aspect of the invention, there is provided a mobile application adapted to run on a user mobile device, the mobile application being adapted to enable the user to:
capture an image using a mobile device, the image being associated to an object;
obtain the user/mobile device location and/or contextual search information;
transmit the captured image along with the user/mobile device and/or contextual search information to a remote server via a wireless data network using the mobile device, the remote server comprising an image recognition processing unit adapted to process the captured image on light of the user/mobile device and/or contextual search information for identifying the object related to the captured image;
receive an identification of the object associated with the captured image;
receive landmark information associated with the identified object;
display the identified object and the landmark information to the user using a user interface; and
enable the user to conduct transactions using the retrieved landmark information using the mobile device.

In an embodiment of the above aspect, if the image recognition unit fails to exactly identify the captured image, the mobile application is adapted to receive a list of possible objects (matches) and to enable the user to select an object among the possible objects; if the user confirms an object as an accurate match, the server sends query to an objects database to obtain relevant information about the identified object.

In an embodiment of the invention, if the user rejects the list of possible objects (matches) to be accurate, the mobile application is adapted to receive from the server a list of possible matches based on the location of the user/mobile device and/or contextual search information. The user may select one of the possible matches or capture the image again using the mobile device.

In an embodiment of the invention, there is provided a mobile device running the mobile application described above and in communication with the server described above.

In an embodiment of the invention, there is provided a computer readable medium embedding computer instructions adapted to implement the mobile application described above when running on a processing unit, such as a mobile device processing unit.

In an embodiment of the invention, there is provided a computer readable medium embedding computer instructions adapted to implement the object identification process described above when running on a processing unit, such as a server processing unit.

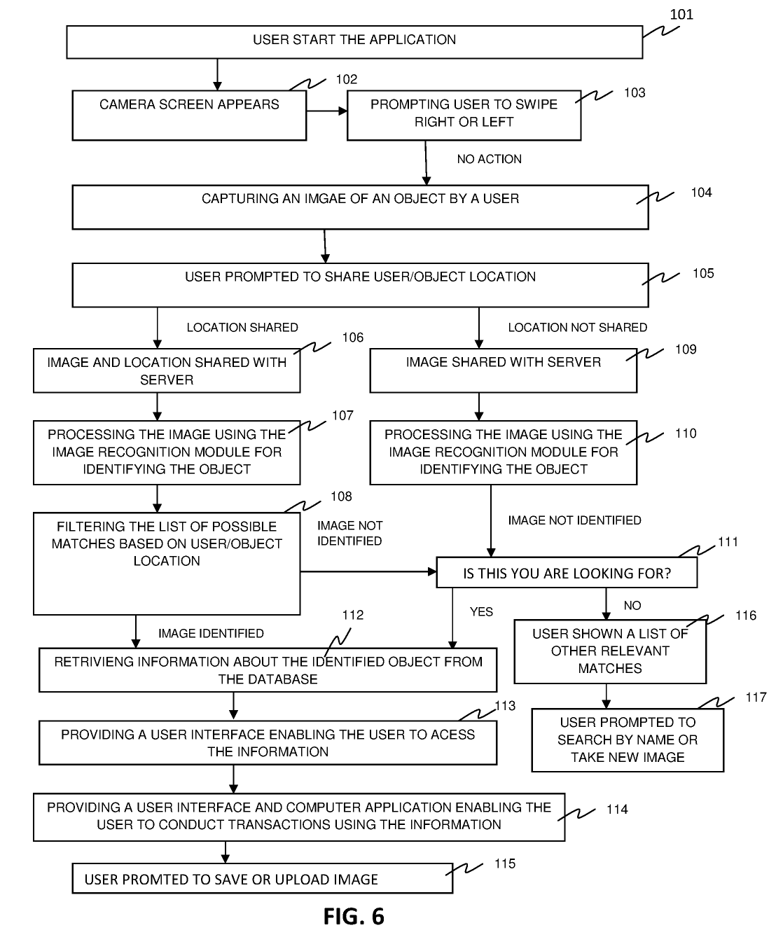

Referring to FIG. 6, there is provided a process for processing information about an object based on user/mobile device location and/or user's contextual search information, the process comprising the steps of launching the mobile application on the mobile device 101, opening the camera screen 102 and prompting the user to swipe either right or left 103 to access other options of the application, capturing an image of a desired object by a user 104, prompting the user to share the location of the user/mobile device 105, if location shared by the user, sharing the image captured and location information with the server 106, processing the image using an image recognition module for identifying the object 107, filtering the list of possible matches based on the location information of the location identification module and/or prediction module to identify the object 108, if location is not shared by user, sharing only the image captured with the server 109, processing the image using an image recognition module for identifying the object 110, if the captured image is not identified, prompting the user with the prompt “is this you are looking for?” 111, if either the image is identified or the most relevant match is confirmed by the user to be correct, retrieving the information about the identified object from an objects database storing data mapping object identifiers to object related information 112, enabling user access to the object related information though a user interface at the mobile device 113, and enabling the user to conduct transactions using the information 114, user prompted to save the captured image or upload image for use by prediction module 115, if the most relevant match confirmed by the user to be incorrect, showing the user with list of relevant matches 116, if not correct then user is prompted to search by name or take a new image 117.

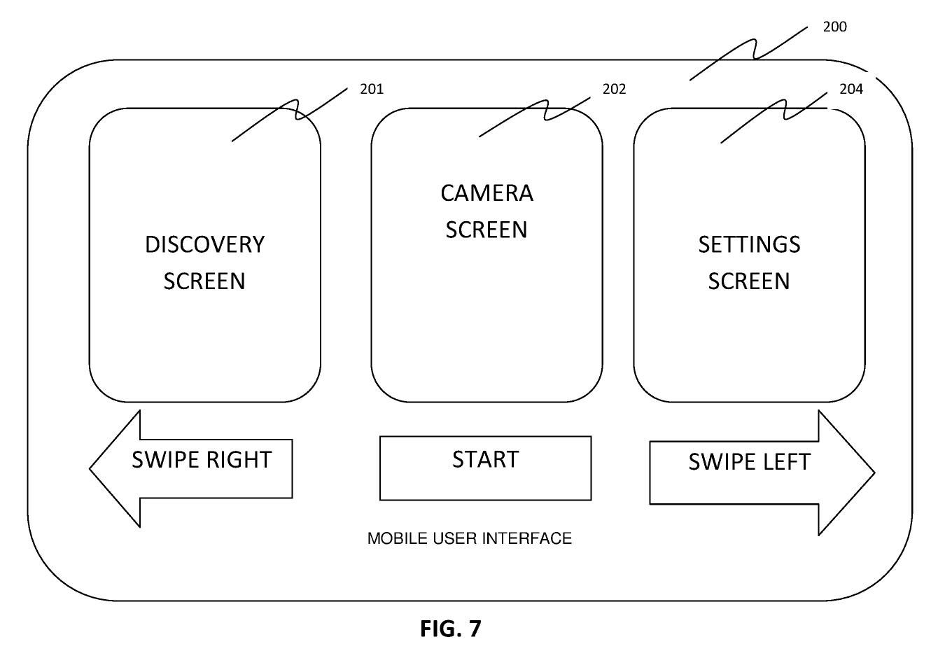

Referring to FIGS. 6 and 7, as explained above, the process for mobile application 20 loads to reach to the camera screen 202 on the mobile user interface 200 and the mobile application 20 prompts user to swipe right or left 103. The user may swipe right to access the discovery screen 201 of the mobile application 20. The discovery screen allows the user to manually browse through the map or listing of location based on the current geographical location of the user/mobile device. For example, standing on Sheik Zayed Road in Dubai UAE, will load a map or listing including the Shangrilla hotel, Duset Dubai, Dubali Mall, Burj Khalifa and any other key location of the area. It may also shows particular locations like coffee shops and restaurants within limited proximity of the current position of the user. The discovery screen may further give the user the ability to search and see that where are the images captured by users located in the map. The images can be located across the map.

As a further aspect of the invention, there is provided a map adapted to disclose images of the possible objects of interest based on the systems and processes implemented according to the present invention.

The user swipes left on the mobile user interface 200 to go the setting screen 204 which provides many option to the user like register and login window to the application, options for changing key settings of the application, view information about the company and/or application and other control options.

The functionality details of the information processing system and method can be further explained by means of the following examples which do not limit the scope of the present invention.

### EXAMPLE 10

The user starts the mobile application. The application is loaded and takes the user to the camera screen. The user uses the camera of the mobile device to capture the image of a landmark near Sheik Zayed Road. The mobile application prompts the user to share his location with the location identification module. The user shares his physical location using the global positioning system (GPS). The captured image and physical location of the user is processed by using the image processing unit and server. The image recognition unit identifies the image using as Burj Khlaifa using the captured image and/or filters the possible list of identified results (burj Khliafa, Burj Al Arab etc) based on the physical location shared by the user to exactly identify the image as Burj Khalifa. The mobile application prompts the user with the identified image and the server identifies the fashion outlet, restaurants, and activities in Burj Khlaifa and further retrieves information such as any promotional offers available, sales, other special offers, available products from the external objects databases. The information retrieved is provided to user by means of user interface. The user interface allows the user to access the information to select the desired information such as hotel reservation, booking for activities and further enables the user to conduct desired transactions such as browsing and booking by connecting to the third party servers such as the office website of the hotels to complete the transaction. The search may be saved in the mobile application to generate user searching habits.

### EXAMPLE 11

The user starts the mobile application. The application is loaded and takes the user to the camera screen. The user uses the camera of the mobile device to capture the image of a landmark near Sheik Zayed Road. The mobile application prompts the user to share his location with the location identification module. The user does not share his physical location. The captured image is processed by using the image processing unit and server. The server identifies the image using as Burj Khalifa using the captured image. If the captured image is not identified by the server, the server identifies the best possible match and prompts the user with a message such as “is it what you were looking for?”. If the best match shown by the mobile application is Burj Khalifa, the user press “Yes” and the server identifies the captured image. However, if the best possible match is not Burj Khalifa, the user press “No” and the server shows the other best match. Further if sever is unable to identify the captured image it prompts the user search by name or take a new picture.

### EXAMPLE 12

The user starts the mobile application. The application is loaded and takes the user to the camera screen. The user uses the camera of the mobile device to capture the image of a landmark near Sheik Zayed Road. The mobile application prompts the user to share his location with the location identification module. The user may or may not share his physical location. The captured image and the physical location if shared are processed by the image processing unit and server. If the captured image is not identified by the image processing unit a list of possible matched are selected based on the location information and the best possible match is identified based on the user's searching habits using the prediction module. If the user has searched for shopping malls several times the prediction module will predict the best possible match to be Dubai mall. The server identifies the best possible match and prompts the user with a message such as “is it what you were looking for?”. If the best match shown by the mobile application is Burj Khalifa, the user press “Yes” and the server identifies the captured image. However, if the best possible match is not Burj Khalifa, the user press “No” and the server shows the other best match. Further if sever is unable to identify the captured image it prompts the user search by name or take a new picture.

### EXAMPLE 13

The user starts the mobile application standing on one of the corner of Interchange 1 on Sheikh Zayed Road in Dubai UAE. The application is loaded and takes the user to the camera screen. The mobile application prompts the user for swiping right or left. If the user swipes right, the interactive map is loaded. The map shows the physical location of the user and lists the major landmarks such as Shagrila Hotel, Duset Dubai, Muruj Rotana, Dubai Mall, Burj Khlaifa, and other key locations in the vicinity. The map further highlights the places of user's interest such as women clothing store or nearest coffee shop.

1. A system comprising a server adapted to be connected to a mobile application running on a mobile device for receiving an image captured by the mobile device and a user or mobile device location, the server being further adapted to be connected to an objects database comprising objects related images and objects related information, the server being further adapted to implement an object identification process comprising the steps of:
searching in the objects database and compiling a list of possible objects as a function of the location of the user or mobile device, where the possible objects are those located within a given geographical zone from the location of the user or mobile device;
comparing the captured image to the possible objects for determining if there is a match with any one of these possible objects;
if a match is found between the captured image and one of the possible objects, determining the identity of the object associated with the captured image.

2. The system of claim 1 wherein the server is further adapted to receive contextual search information form the mobile application, the object identification process further comprising the steps of:
searching in the objects database and compiling a list of possible objects as a function of contextual search information, where the possible objects are those being within the same category of objects searched by the user according to the contextual search information;
comparing the captured image to the possible objects for determining if there is a match with any one of these possible objects;
if a match is found between the captured image and one of the possible objects, determining the identity of the object of interest associated with the captured image.

3. The system of claim 2 wherein the search based on the location of the user or mobile device is conducted before the search based on the contextual search information, and wherein the search based on the contextual search information is conducted based on the list of possible objects obtained by conducting the search based on the user or mobile device location.

4. The system of claim 2 wherein the search based on the contextual search information is conducted before the search based on the mobile device or user location, and wherein the search based on the mobile device or user location is conducted based on the list of possible objects obtained by conducting the search based on the contextual search information.

5. The system of claim 3, wherein the object determination process comprises:
First, comparing the captured image with all objects' related images stored inside the objects database for determining if a match can be found;
Second, if a perfect match cannot be found, compiling a list of possible objects based on the comparison process in the first step where the possible objects are those having a certain degree of resemblance with the captured image but not a complete match;
Third, filtering the list of possible objects based on the user or mobile device location and/or the contextual search information, where the filtering process comprises determining the objects among the possible objects which are located within a given geographical zone from the location of the user or mobile device and/or which are within the same category of objects searched by the user according to the contextual search information;
Fourth, if a match is found between the captured image and one of the filtered objects, determining the identity of the object associated with the captured image;
Fifth, if a match is not found, obtaining and sending the filtered list of objects to the user for selection of the right object of interest among the filtered list of objects.

6. The system of claim 4, wherein the object determination process comprises:
First, comparing the captured image with all objects' related images stored inside the objects database for determining if a match can be found;
Second, if a perfect match cannot be found, compiling a list of possible objects based on the comparison process in the first step where the possible objects are those having a certain degree of resemblance with the captured image but not a complete match;
Third, filtering the list of possible objects based on the user or mobile device location and/or the contextual search information, where the filtering process comprises determining the objects among the possible objects which are located within a given geographical zone from the location of the user or mobile device and/or which are within the same category of objects searched by the user according to the contextual search information;
Fourth, if a match is found between the captured image and one of the filtered objects, determining the identity of the object associated with the captured image;
Fifth, if a match is not found, obtaining and sending the filtered list of objects to the user for selection of the right object of interest among the filtered list of objects.

7. The system of claim 5 wherein the steps of the object identification process are conducted in the same order as recited.

8. The system of claim 6 wherein the steps of the object identification process are conducted in the same order as recited.

9. The system of claim 7 wherein the server is further adapted to obtain landmark information related to the object of interest and transmitting the landmark information to the mobile device.

10. The system of claim 8 wherein the server is further adapted to obtain landmark information related to the object of interest and transmitting the landmark information to the mobile device.

11. The system of claim 9, wherein the mobile application is adapted to enable the user of the mobile device to:
capture the image using a mobile device, the image being associated to an object;
obtain the user or mobile device location and/or contextual search information;
transmit the captured image along with the user/mobile device and/or contextual search information to a remote server via a wireless data network using the mobile device;
receive an identification of the object associated with the captured image;
receive landmark information associated with the identified object;
display the identified object and the landmark information to the user using a user interface; and
enable the user to conduct transactions using the retrieved landmark information using the mobile device.

12. The system of claim 10, wherein the mobile application is adapted to enable the user of the mobile device to:
capture the image using a mobile device, the image being associated to an object;
obtain the user or mobile device location and/or contextual search information;
transmit the captured image along with the user/mobile device and/or contextual search information to a remote server via a wireless data network using the mobile device;
receive an identification of the object associated with the captured image;
receive landmark information associated with the identified object;
display the identified object and the landmark information to the user using a user interface; and
enable the user to conduct transactions using the retrieved landmark information using the mobile device.

13. A mobile application adapted to run on a processing unit of a mobile device for:
Enabling a user to capture an image using a mobile device, the image being associated to an object;
obtain the user or mobile device location and/or contextual search information;
transmit the captured image along with the user or mobile device and/or contextual search information to a remote server via a wireless data network using the mobile device, the remote server comprising an image recognition processing unit adapted to process the captured image on light of the user or mobile device and/or contextual search information for identifying the object related to the captured image;
receive an identification of the object associated with the captured image;
receive landmark information associated with the identified object;
display the identified object and the landmark information to the user using a user interface; and
enable the user to conduct transactions using the retrieved landmark information using the mobile device.

14. The mobile application of claim 13 wherein the remote server is further adapted to be connected to an objects database comprising objects related images and objects related information, the server being further adapted to implement an object identification process comprising the steps of:
searching in the objects database and compiling a list of possible objects as a function of the location of the user or mobile device, where the possible objects are those located within a given geographical zone from the location of the user or mobile device;
comparing the captured image to the possible objects for determining if there is a match with any one of these possible objects;
if a match is found between the captured image and one of the possible objects, determining the identity of the object associated with the captured image.

15. The mobile application of claim 14 wherein the server is further adapted to receive contextual search information from the mobile application, the object identification process further comprising the steps of:
searching in the objects database and compiling a list of possible objects as a function of contextual search information, where the possible objects are those being within the same category of objects searched by the user according to the contextual search information;
comparing the captured image to the possible objects for determining if there is a match with any one of these possible objects;
if a match is found between the captured image and one of the possible objects, determining the identity of the object of interest associated with the captured image.

16. The mobile application of claim 15, wherein the object determination process further comprises:
First, comparing the captured image with all objects' related images stored inside the objects database for determining if a match can be found;
Second, if a perfect match cannot be found, compiling a list of possible objects based on the comparison process in the first step where the possible objects are those having a certain degree of resemblance with the captured image but not a complete match;
Third, filtering the list of possible objects based on the user or mobile device location and/or the contextual search information, where the filtering process comprises determining the objects among the possible objects which are located within a given geographical zone from the location of the user or mobile device and/or which are within the same category of objects searched by the user according to the contextual search information;
Fourth, if a match is found between the captured image and one of the filtered objects, determining the identity of the object associated with the captured image;
Fifth, if a match is not found, obtaining and sending the filtered list of objects to the user for selection of the right object of interest among the filtered list of objects.

17. A mobile device running a mobile application adapted to:
Enable a user to capture an image using a mobile device, the image being associated to an object;
obtain the user/mobile device location and/or contextual search information;
transmit the captured image along with the user/mobile device and/or contextual search information to a remote server via a wireless data network using the mobile device, the remote server comprising an image recognition processing unit adapted to process the captured image on light of the user/mobile device and/or contextual search information for identifying the object related to the captured image;
receive an identification of the object associated with the captured image;
receive landmark information associated with the identified object;
display the identified object and the landmark information to the user using a user interface; and
enable the user to conduct transactions using the retrieved landmark information using the mobile device.

18. The mobile device of claim 17 wherein the remote server is further adapted to be connected to an objects database comprising objects related images and objects related information, the server being further adapted to implement an object identification process comprising the steps of:
searching in the objects database and compiling a list of possible objects as a function of the location of the user or mobile device, where the possible objects are those located within a given geographical zone from the location of the user or mobile device;
comparing the captured image to the possible objects for determining if there is a match with any one of these possible objects;
if a match is found between the captured image and one of the possible objects, determining the identity of the object associated with the captured image.

19. The mobile device of claim 18 wherein the server is further adapted to receive contextual search information from the mobile application, the object identification process further comprising the steps of:
searching in the objects database and compiling a list of possible objects as a function of contextual search information, where the possible objects are those being within the same category of objects searched by the user according to the contextual search information;
comparing the captured image to the possible objects for determining if there is a match with any one of these possible objects;
if a match is found between the captured image and one of the possible objects, determining the identity of the object of interest associated with the captured image.

20. The mobile device of claim 19, wherein the object determination process further comprises:
First, comparing the captured image with all objects' related images stored inside the objects database for determining if a match can be found;
Second, if a perfect match cannot be found, compiling a list of possible objects based on the comparison process in the first step where the possible objects are those having a certain degree of resemblance with the captured image but not a complete match;
Third, filtering the list of possible objects based on the user or mobile device location and/or the contextual search information, where the filtering process comprises determining the objects among the possible objects which are located within a given geographical zone from the location of the user or mobile device and/or which are within the same category of objects searched by the user according to the contextual search information;
Fourth, if a match is found between the captured image and one of the filtered objects, determining the identity of the object associated with the captured image;
Fifth, if a match is not found, obtaining and sending the filtered list of objects to the user for selection of the right object of interest among the filtered list of objects.
